(19) United States
(12) Patent Application Publication
(10) Pub. No.: US 2008/0151535 A1
(43) Pub. Date: Jun. 26, 2008

(54) LED lighting device for refrigerated food merchandising display cases

(76) Inventor: Pierre de Castris, Montreal (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/644,825

(22) Filed: Dec. 26, 2006

(51) Int. Cl. F21V 19/02; F21V 11/00

(52) U.S. Cl. 362/220; 362/240

(57) ABSTRACT

A multiple LED lighting device and appropriate electrical components integrated into two versions and serving as a direct replacement for conventional fluorescent lighting used in refrigerated food merchandisers. Both versions include appropriate connectors and pins, enabling the LED lighting device to be installed directly in a food merchandising display case lighting fixture. The LED lighting supply circuit may include appropriate electrical components such as rectifiers, step-down transformers, regulators and colour rendering controls to provide the required voltage for the LEDs and appropriate light spectrum. The electrical components may be mounted either integrally within the device, incorporated in an end cap thereof, or installed separately within the refrigerated food merchandising display case. The light may be coloured within the permissible light spectrum by the use of appropriate LEDs and drivers providing the desired coloured lighting.

This present invention relates to an LED lighting device for use as a replacement of fluorescent lights in a light tube fixtures mounted in refrigerated food display cases and more specifically to an LED lighting device having reduced energy consumption and reduce heat generation.

### BACKGROUND OF THE INVENTION

For many years the lighting of the interiors of refrigerated food merchandising display cases has been accomplished with the use of fluorescent lighting systems. However, fluorescent lights possess many characteristics which constitute major disadvantages for the food store owners. The disadvantages include the short lifetime of the fluorescent lighting tube, low efficiency at low temperatures approaching freezing temperatures and below freezing temperatures, high power requirements, counter productive heat injection within the refrigerated volume, low durability and high electromagnetic interference which can be detrimental to other electrical systems. In addition, specialty versions of fluorescent lighting systems incorporating higher intensity light and plastic shield protection against cold temperatures are not economical and do not prevent heat generation inside the refrigerated volume. Moreover, the reduction in lighting intensity under cold temperatures below zero can reach as much as 80%.

The recent innovation in lighting systems eliminates many of these disadvantages. The use of light emitting diodes (LEDs) in lighting systems has allowed many of the disadvantages of fluorescent lighting systems to be avoided. LED lighting systems are typically low power, have a greatly enhanced lifetime and have lower electromagnetic interference.

A number of different principles of electrical lighting have been developed over the years. Incandescent lighting was the first lighting principle to receive widespread use, and is still the most widely used lighting principle used to date. More recently, the principle of electrically exciting a gas to produce light emission from the gas has been used to produce usable light in the form of fluorescent lighting fixtures and the like.

Fluorescent lighting operates according to the principle of ionizing a gas contained within a sealed tube. The electrically excited gas produces light emission as it returns to its normal energy level. The light spectrum depends upon the type of gas within the tube, but conventional fluorescent lighting emits light in the ultraviolet spectrum, which is converted to visible light as it encounters the coating within the tube and causes the coating to fluoresce. Such fluorescent lighting also requires a relatively high voltage to produce the required ionization of the gas. This voltage may be provided by a starter which provides an inductive kick when current is shut off or reversed, the ballast serving to limit current in the arc between the filaments, or by high voltage windings loosely wound on the ballast itself in rapid start fluorescent lights.

More recently, other technologies for lighting and for use in lighting systems have been developed. The LED, or light emitting diode, operates generally as a conventional diode, i.e., allowing electrical current to pass through the device in, one direction while blocking current flow in the opposite direction. During this operation, the passage of electrical current through special materials used as the diode device also causes light to be emitted as the diode reaches saturation. Through years of research, different colors of light emission, light intensity, and other factors have been developed and improved, such as power consumption. A discussion of the known related art and its differences and distinctions from the present invention, will now be discussed.

U.S. Pat. No. 4,941,072 issued on Jul. 10, 1990 to Masami Yasumoto et al., titled “Linear Light Source,” describes a linear LED array and semi-cylindrical section lens therefore. Yasumoto et al. does not disclose any specific means for securing their lighting device in any form of fixture, fluorescent or otherwise, and do not disclose any form of electrical apparatus for adapting the relatively low voltage requirements of an LED circuit to the necessarily higher voltage of a fluorescent fixture or even conventional line current.

U.S. Pat. No. 4,943,900 issued on Jul. 24, 1990 to Klaus Gartner, titled “Lighting Fixture,” describes a number of miniature incandescent bulbs electrically connected in series within a translucent tube. Gartner is directed particularly to end attachment means for his lighting tube, with each end connector comprising a male connector which fits into a female socket in the end of the tube. Each end of the Gartner tube contains only a single electrical conductor. The Gartner lighting device is thus incompatible with a fluorescent fixture, with its requirement for two parallel male electrical connector pins extending from each end of the lighting element, as provided by the present LED replacement device for fluorescent lighting.

U.S. Pat. No. 5,032,960 issued on Jul. 16, 1991 to Masaaki Katoh, titled “Light Source Device With Arrayed Light Emitting Elements And Manufacturing Therefore,” describes an LED lighting array comprising a linear group of LEDs installed beneath a semi-cylindrical converging lens. Katoh does not disclose any means for connecting his lighting array electrically or physically with a lighting fixture, and does not disclose any electrical apparatus for adapting his LED array for use in a conventional fluorescent lighting fixture, as provided by the present LED replacement lighting device.

U.S. Pat. No. 5,515,253 issued on May 7, 1996 to Fritz C. Sjobom, titled “L.E.D. Light Assembly,” describes a specific lens configuration for diffusing the light produced by an LED lighting array. Sjobom provides a plurality of LEDs on a circuit board, and overlays the assembly with his lens. The Sjobom LED lighting array is not installed within a hollow translucent tube nor disposed along a solid translucent rod, as is the case with the present LED lighting apparatus. Moreover, Sjobom does not disclose any form of end connectors for his lighting array, nor does he disclose any electrical apparatus for adapting an LED array for use with the higher voltage of a conventional fluorescent lighting system or 110-115 volt AC supply, as provided by the present LED replacement for fluorescent lighting invention.

U.S. Pat. No. 5,688,042 issued on Nov. 18, 1997 to Abolfazl Madadi et al., titled “LED Lamp,” describes an elongate bulb having an attachment base at only one end thereof. The lamp includes three elongate circuit boards, each having a series of LEDs installed thereon. The circuit boards are installed within the bulb to emit light in a general omni-directional pattern. Madadi et al. do not provide any form of reflector or diffuser means with their light, as they intend it to be installed within a double faced, back lighted sign (e.g., exit signs, etc.). Moreover, as they intend their light to be used only in such relatively compact installations, they do not provide the conventional double parallel pin connectors at each end of the bulb, as is provided in the present LED replacement lighting.

U.S. Pat. No. 5,810,463 issued on Sep. 22, 1998 to Atsushi Kawahara et al., titled “Illumination Device,” describes an LED lighting device having either a row of LEDs which send their light through a generally cylindrical lens with reflectors thereon, or which may include an array of LEDs at one end of the lens. The lens of the Kawahara et al. lighting device includes a lateral extension, the end or edge of which is adjacent to the linear LED array. This shape is not compatible with installation within a conventional fluorescent light fixture, as provided by the present invention. Moreover, Kawahara et al. do not disclose any electrical apparatus to provide compatibility with the relatively high voltages of a fluorescent lighting system or even conventional household supply current, as provided by the present invention.

U.S. Pat. No. 6,068,383 issued on May 30, 2000 to Roger Robertson et al., titled “Phosphorous Fluorescent Light Assembly Excited By Light Emitting Diodes,” describes a fluorescent lighting device which produces light in the visible spectrum by means of a fluorescent coating within the lighting apparatus, which in turn is excited by ultraviolet light produced by a number of LEDs within the device. The device of the Robertson et al. is more closely related to a conventional fluorescent lighting assembly, than to the present invention. The only difference between the assembly of the Robertson et al. '383 U.S. patent and conventional fluorescent fixtures, is that conventional fluorescent lighting produces light in the ultraviolet spectrum by means of ionizing a gas within a tube, with the ultraviolet light produced by the ionized gas causing the fluorescent coating within the tube to fluoresce to produce light in the visible spectrum. The present invention does not produce any form of ultraviolet light; all light produced by the LEDs used in the present lighting apparatus, comprises light in the visible spectrum. There is no need to convert light from the ultraviolet spectrum to the visible spectrum, in the lighting system of the present invention. Moreover, the Robertson et al. '383 U.S. patent does not disclose any physical configuration for a lighting device which enables it to be installed within a conventional fluorescent lighting fixture, as provided by the present LED replacement for fluorescent lighting invention.

U.S. Pat. No. 6,139,174 issued on Oct. 31, 2000 to Mark M. Butterworth, titled “Light Source Assembly For Scanning Devices Utilizing Light Emitting Diodes,” describes a solid translucent rod which accepts blue light from an appropriate LED at one end thereof, and transmits the light outwardly through the side of the rod. A pair of fluorescent strips along the side of the rod produce light in different spectra, with a third strip passing the blue light therethrough. The Butterworth light apparatus is adapted for use in a scanning device, as are many of the lighting devices of the prior art discussed further above. Accordingly, no means of installing or operating the Butterworth apparatus in a conventional fluorescent lighting fixture is disclosed.

U.S. Pat. No. 6,283,612 issued on Sep. 4, 2001 to Mark A. Hunter, titled “Light Emitting Diode Light Strip,” describes an elongate translucent tube with a plurality of LEDs installed in series therein. However, Hunter utilizes a separate power supply to step down the voltage from the conventional 110-220 volt supply to the reduced voltage required even for a series of LEDs. The Hunter power supply is a separate box, wired in series with the light by an elongate flexible cable and removable connector. Moreover, each end of the Hunter lamp includes a flexible cable extending therefrom, which is not compatible for installation in a conventional fluorescent light fixture. In addition, Hunter does not disclose any form of light reflecting or diffusing means for scattering the directional light of the LEDs in a wide spread pattern, as provided by the present invention.

U.S. Pat. No. 6,331,915 issued on Dec. 18, 2001 to Kenneth J. Myers, titled “Lighting Element Including Light Emitting Diodes, Microprism Sheet, Reflector, And Diffusing Agent,” describes sheet(s) of material having a series of prismatic reflective grooves formed therein, and the placement of LEDs along the grooves. A number of additional means of diffusing or scattering the light emitted by the LEDs, is also described generally by Myers. However, the only electrical power source indicated in the Myers disclosure, is a conventional symbol for a battery across two of the LEDs in one of the drawing Figs. There is no description of this battery.

U.S. Pat. No. 6,388,393 issued on May 14, 2002 to Lewis Illingworth, titled “Ballasts For Operating Light Emitting Diodes In AC Circuits,” describes various embodiments of inductor and transformer devices for reducing voltage and current to proper levels, for powering LED lighting devices in an aircraft electrical system. Illingworth does not describe any type of connectors for connecting an LED light array in a fluorescent fixture, nor does he describe any means for reflecting or diffusing the light output from an LED array, which features are a part of the present invention. Moreover, Illingworth is directed to relatively low voltages, and particularly DC electrical power systems, as used in aircraft. Accordingly, he teaches away from the present invention, with its “drop-in” replacement in a fluorescent lighting fixture.

None of the above discussed patented prior art, taken either individually or in combination, is seen to describe the present invention.

It is an important feature of the present invention to use LEDs in a lighting fixture to benefit from its low power consumption and apply it to refrigerated food merchandising display cases.

LED lighting systems provide many other advantages in the present application. LEDs are relatively cool in operation, and do not produce any significant amount of heat as a by product of their operation. Moreover, they are quite efficient in comparison to other types of lighting principles. LEDs are available in a number of different colors, and the lighting intensity may be varied by means of a simple variable resistor or rheostat, unlike other lighting systems. However, even with recently developed “super bright” LEDs, the light output of a single LED is relatively weak in comparison to a conventional fluorescent light unit at room temperature. Nonetheless, multiple LED assemblies in a single unit or fixture can provide an equivalent amount of light to a fluorescent light fixture especially at freezing temperatures. These advantages are discussed in an article entitled “Refrigerated Display Case Lighting with LEDs” by Ramesh Raghavan et al, Rensselaer Polytechnic Institute, Troy, N.Y. 12180.

Another feature of the present invention is to benefit from the fact that LEDs do not generate heat and that they are available in different colors and which features are advantageous for use to shed light on refrigerated food in merchandising display cases.

Another feature of the present invention is to provide a solution to the problems of fluorescent lighting by providing a replacement lighting unit for a fluorescent lighting tube. The present replacement lighting units comprise two embodiments of built-in or built-out AC/DC power conversion and multiple LEDs. The lighting units are equipped with support and connectors allowing installation in the conventional fluorescent light tube fixture. The present invention also includes the electrical components required to adapt the operation of an LED array to the electrical system of a fluorescent lighting fixture, with such electrical components being provided either internally within the replacement lighting unit (built-in) or externally (built-out), as needed. The present invention also provides components and controls to adjust the light intensity and spectral output.

The present invention can be constructed in two versions of an LED lighting unit. A first LED lighting unit version consisting in a number of light emitting diodes (LEDs) arranged linearly as to produce a desired light intensity comparable to fluorescent lighting fixtures and serving as a direct replacement for a conventional fluorescent lighting fixture, with the present lighting device utilizing an integrated power converter and a second LED lighting unit embodiment consisting of a number of light emitting diodes (LEDs) arranged linearly as to produce a desired light intensity comparable to fluorescent lighting fixtures and utilizing an external power module. The two LED lighting units embodiment presented having LEDs disposed linearly using a printed circuit board held by a aluminium fixture also serving as a heat sink. The LEDs may be in a series or parallel circuit array as desired. The circuit board 3 can be an elongated board of two or more boards secured end-to-end.

In one version, the aluminium fixture of the present invention which contains the LED lighting printed circuit board, is equipped with fluorescent light receptacle connector pins at each end thereof, in the manner of a conventional fluorescent tube. The power conversion components, such as rectifier, transformer, LED light spectrum modulation and intensity setting may be built into the aluminium fixture located at one end of the LED lighting unit.

In a second version, the aluminium fixture of the present invention which contains the LED lighting printed circuit board, is equipped with a common two pin connector at one end, in the manner as to allow the connection of a suitable external AC/DC power source. The LED light spectrum modulation and intensity setting may be built into the aluminium fixture and located at one end of the LED lighting unit. In this present embodiment, the power conversion is accomplished within the external AC/DC power source.

In the two versions presented, the aluminium fixture containing the printed circuit board on which LEDs are disposed, also contains a reflective surface allowing the LED light to be propagated into a set direction forming a proper angle of projection within the refrigerated food merchandiser. The reflective coating is produced at the time of extrusion.

Accordingly, it is a feature of the present invention to provide a lighting unit using the LED lighting principle and internal power conversion for use as a direct replacement for a fluorescent tube within refrigerated food merchandisers.

It is a further feature of the present invention to provide a lighting unit which utilize an external AC/DC power source as to satisfy the needs of other refrigerated food merchandiser lighting requirements and configurations.

It is a further feature of the present invention to provide a replacement LED lighting device including the required electrical components for compatibility integrated within the lighting unit, or disposed externally to the LED lighting unit.

Still another feature of the present invention is to provide a LED lighting device for refrigerated food merchandisers which may include a LED light spectrum modulation and intensity setting within a range acceptable by food inspection authorities.

Still another feature of the present invention is to provide a LED lighting device for refrigerated food merchandisers which may include a LED light spectrum modulation and intensity setting within the LED lighting unit or at the refrigerated food merchandiser level.

According to the above features the present invention provides an LED (light emitting diode) lighting device for connection into end connectors of a conventional fluorescent lighting fixture for replacement of fluorescent tubes. The device comprises an elongated rigid support body having pin connectors at opposed ends thereof. The pin connectors are each provided with a pair of electrical connecting pins extending exteriorly thereof in a spaced-apart configuration for operatively engaging the end connectors. Circuit board means is secured along the rigid support body. A plurality of LEDs are secured together and to the circuit board means. Power conversion circuit means supplied the necessary voltage to the LEDs connected together.

The LED lighting device of the present invention was developed preferably, but not exclusively, for replacement of fluorescent lighting tubes in fluorescent lighting fixtures secured in refrigerated merchandising display cases which displays foodstuff.

### BRIEF DESCRIPTION OF THE DRAWINGS

A preferred embodiment of the present invention will now be described with reference to the accompanying drawings in which:

FIG. 1 is a side elevation view of the LED lighting device provided with an internal power source;

FIG. 2 is a side elevation view of the LED lighting device provided with an external power source;

FIG. 3 is a cross sectional view of a refrigerated food merchandising display case showing the installation of an LED lighting device of the present invention as provided with an internal power source;

FIG. 4 is a cross sectional view of a refrigerated food merchandising display case showing the installation of an LED lighting device of the present invention with an external power source;

FIG. 5 is a ballast wiring diagram of a prior art fluorescent lamp fixture; and

FIG. 6 is a wiring diagram of the lighting device of the present invention.

### DETAILED DESCRIPTION OF THE PREFERRED EMBODIMENTS

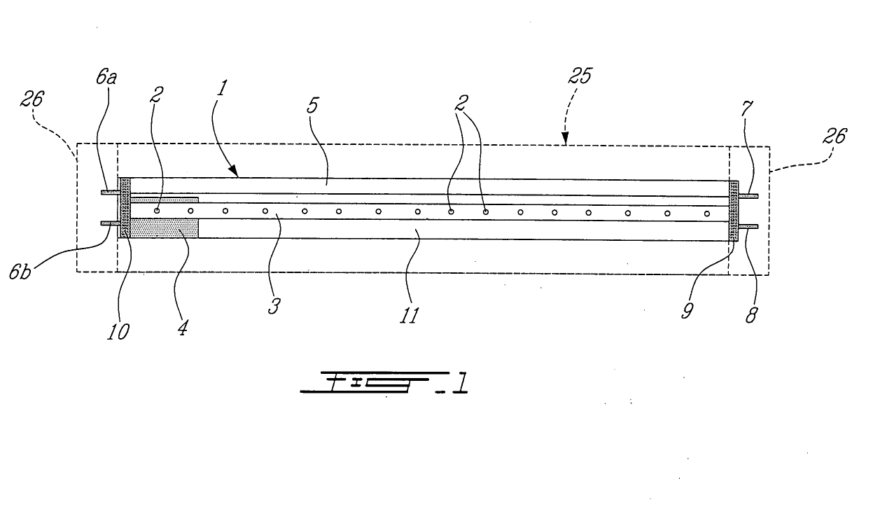

The present invention discloses two embodiments of an LED lighting device 1 adapted for installation in refrigerated food merchandising display cases as a replacement to a conventional fluorescent lighting fixture tube. The present LED lighting device 1 contains multiple light emitting diodes (LEDs) 2 therein, which provide the desired lighting. FIG. 1 of the drawings illustrate the first embodiment LED lighting device 1 provided with an internal power assembly 4 and as a replacement LED lighting device 1, to a fluorescent tube of an existing conventional fluorescent tube lighting fixture 25.

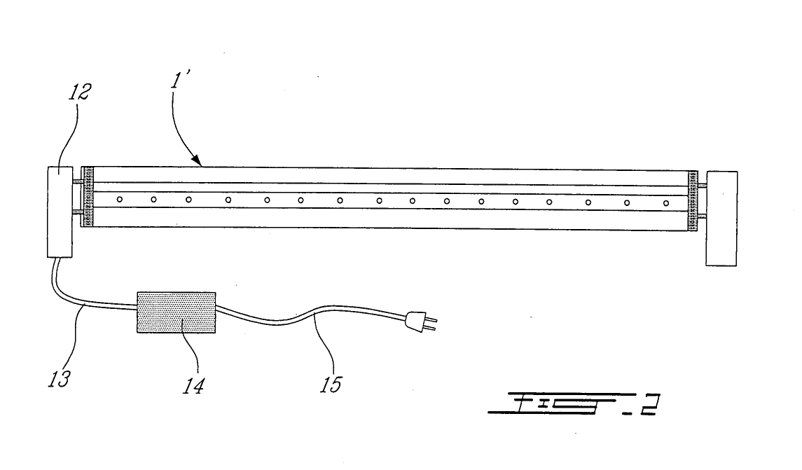

FIG. 2 illustrate the configuration of the second embodiment of the LED lighting device 1′ wherein, the power conversion assembly 14 is installed externally to the LED lighting device by means of a connector 12 and wiring harness 13. Conventional 115 volts AC electrical source is supplied to the power conversion assembly 14 through a connection cable 15 connected to the conventional supply.

While referring to FIG. 1, the LED lighting device 1 is comprised of an aluminium fixture 5 onto which the other components of the LED lighting device are mounted. An LED printed circuit board 3 is mounted onto the aluminium fixture as to allow a secure connection and to provide a heat sink for the heat generated by the LEDs 2 to flow into the aluminium fixture. The LED lighting device 1 is equipped with connector pins 6a, 6b, 7 and 8 arranged similarly to a fluorescent tube whereby to connect to a fluorescent tube fixture and facilitating its replacement. The connector pins 6a, 6b, 7 and 8 are connected to the power conversion assembly 4 by means of connections part of the LED printed circuit board 3 allowing standard fluorescent light ballast current to flow to the power conversion unit 4 which in turns supplies power to the LEDs 2 mounted on the printed circuit board 3. The connector pins 6a, 6b, 7 and 8 are secured in place by pin connectors or end cap connectors 9 and 10. End caps 9 and 10 also secure the aluminium fixture 5 in place at the proper position in the end connectors 26 of the conventional fluorescent tube fixture 25 shown in phantom lines in FIG. 1 as to allow LED lighting to be oriented into a proper direction.

A plurality of light emitting diodes (LEDs) 2 are installed onto the printed circuit board 3. The LEDs 2 are electrically connected to the power conversion assembly 4 through the printed circuit board 3. The power conversion assembly 4 converts the conventional fluorescent lighting ballast high voltage output into a low voltage output suitable to operate the LEDs.

Referring to FIG. 2, the second embodiment of the LED lighting device 1 is shown. The power conversion assembly 14 is shown mounted externally of the device and is used to convert regular 115 volt AC supply voltage to a low voltage suitable to operate LEDs. The present embodiment is used for new installations or new fabrication of refrigerated food merchandising display cases.

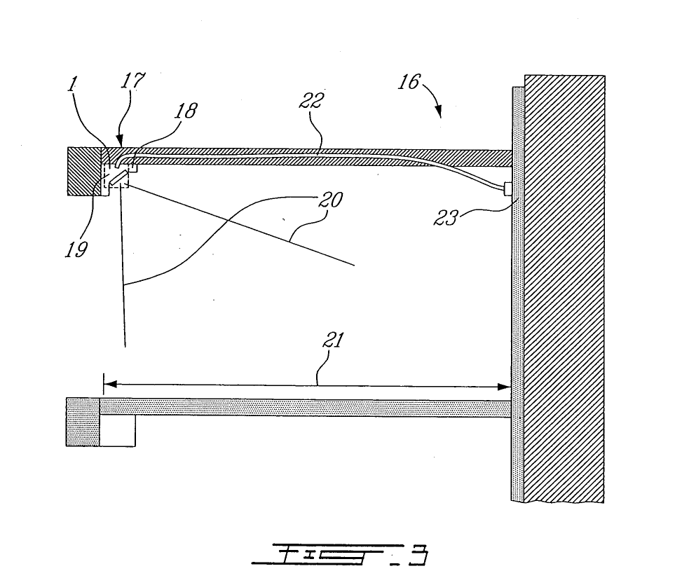

Referring now to FIG. 3 of the drawings, there is illustrated in cross section, a refrigerated food merchandising display cases 16 and a typical frame 17 containing the installation of a LED lighting device 1 as a direct replacement of a fluorescent light tube in a fixture at location 18. Conventional ballast voltage is brought to the lighting unit through cable 22 as it would to power the conventional fluorescent tubes. The LED lighting device 1 can be rotated within end caps 9 and 10 (see FIG. 1) to provide the best possible light projection in the area 21 by the directional beam 20.

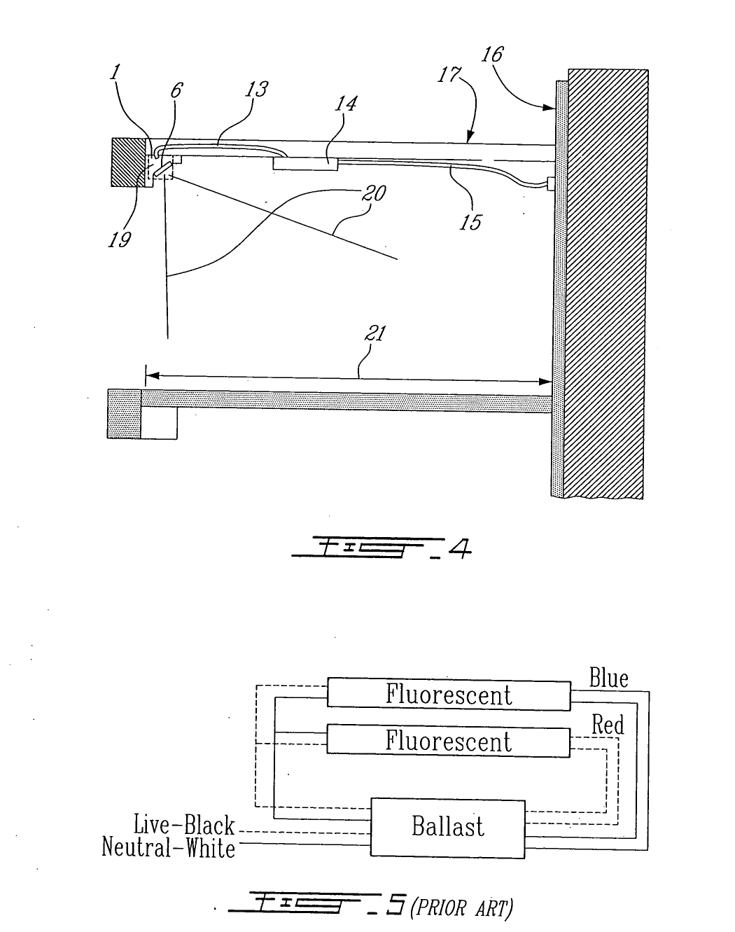

FIG. 4 of the drawings illustrates in cross section, a refrigerated food merchandising display case 16 and typical frame 17 containing a new installation of a LED lighting device 1. The LED lighting device 1′ is powered by the power conversion assembly 14 installed preferably concealed in the structure 17 and 115 AC is brought to the power conversion assembly 14 through cable 15. In turn, the LED lighting device 1′ is powered by low voltage supplied from the power conversion assembly 14 through cable 13.

The LED lighting devices 1 and 1′ may be comprised of LEDs capable of variable spectral light output or combinations of RGB assemblies (red, green and blue LEDs) to allow the production of coloured lighting. The printed circuit board 3 is designed to allow the installation of multiple red, green and blue LEDs to produce light other than pure white light. Although any arrangement of red, green and blue LEDs will produce coloured lighting, the present invention allows the variable spectral light production through adjustments on the power conversion assemblies 4 and 14 and use of super bright white LEDs.

The LED lighting devices 1 and 1′ project light in an angular beam 20 in a direction towards surface 21 that is basically a portion of the surface of a shelf underneath that where the LED lighting device 1 or 1′ is installed. The light projection beam 20 can be moved to maximize lighting by turning the aluminium fixture 5 within the end caps 9 and 10. The aluminium fixture is therefore pivotally connected between the end caps to adjust its angular position. To further enhance the LED lighting device performance, the aluminium fixture 5 provides a reflection cavity 11 (see FIG. 1) which is coated to enhance light reflection.

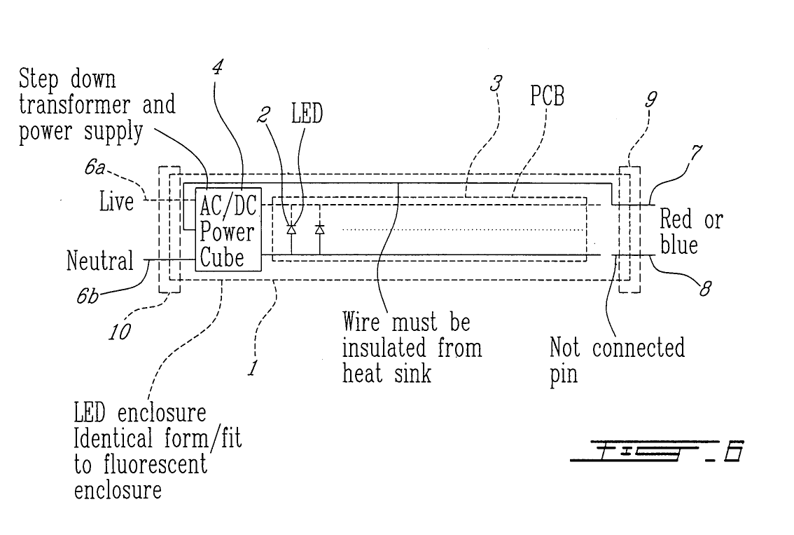

FIG. 5 illustrates a typical ballast wiring diagram of the prior art.

FIG. 6 illustrates the wiring diagram for the replacement LED lighting device of the present invention.

The use of LEDs to supply lighting for a refrigerated food merchandising display case 16, provides numerous advantages over fluorescent lighting systems. Among these advantages is the ability to control the light output level of the LED lighting devices 1 and 1′ by varying the voltage to the LEDs. This is accomplished by means of electronic controls that form part of the power conversion assembly and not shown herein but obvious to a person skilled in the art.

In conclusion, the present LED lighting device 1, for use as direct replacement for fluorescent lighting tubes or as new LED lighting device 1′ for refrigerated food merchandising display cases provides numerous advantages over conventional fluorescent lighting units. The electrical power requirements of LEDs lighting is 30 to 50% less in comparison to most other forms of lighting, thereby saving energy and increasing efficiency in comparison to other lighting forms.

Another advantage of the present invention pertains to the durability of the LED lighting device which is estimated safely at 50,000 hours. Another advantage regards that of comparative performance. LEDs are known to be more efficient at cold temperatures than fluorescent lighting systems. Fluorescent lighting output is greatly affected by freezing temperatures below zero degrees. The LEDs consume less energy, produce less heat and therefore require less energy from the refrigeration system to maintain a substantially stable cool temperature for the foodstuff displayed in the display cases.

It is to be understood that the present invention encompasses any and all modifications that fall within the scope of the appended claims.

1. An LED (light emitting diode) lighting device for connection into end connectors of a conventional fluorescent lighting fixture for replacement of fluorescent tubes, said fluorescent lighting fixture being secured in a refrigerated merchandising display case for displaying foodstuff, said elongated rigid support body being mounted to orient a directional light beam produced by said LEDs onto the foodstuff, said device comprising an elongated rigid aluminum support body having pin connectors at opposed ends thereof, said support body constituting an external heat sink to dissipate heat generated by said power conversion circuit and said LEDs, said pin connectors are each provided with a pair of electrical connecting pins extending exteriorly thereof in a spaced-apart configuration for operatively engaging said end connectors, circuit board means is secured along said rigid support body, a plurality of LEDs are secured together and to said circuit board means in a linear arrangement to form said directional light beam, power conversion circuit means secured to said pin connectors for supplying voltage to said LEDs connected together.

2-5. (canceled)

6. An LED lighting device as claimed in claim 4 wherein said circuit board means is provided by one of an elongated circuit board secured to and along said support body or two or more circuit boards secured to and along said support body.

7. An LED lighting device as claimed in claim 6 wherein said linear arrangement comprises said LEDs connected together in a parallel or series connection and to said power conversion circuit means.

8. An LED lighting device as claimed in claim 7 wherein said power conversion circuit means is provided with a step down transformer and an AC/DC converter.

9. An LED lighting device as claimed in claim 8 wherein said power conversion circuit means is secured to one of said support body at a convenient predetermined location or one of said pin connectors.

10. An LED lighting device as claimed in claim 8 wherein said power conversion circuit means is housed in a casing secured externally of the said lighting device, a connecting supply cable secured to an output of said casing and to one of said end connectors and said casing, and an input cable secured to an input of said casing and to a standard 115 volt AC supply outlet.

11. An LED lighting device as claimed in claim 1 wherein said support body is provided with a reflection cavity having a reflective surface coated with a reflective material to produce an oriented beam of light in a wide spread pattern.

12. An LED lighting device as claimed in claim 11 wherein said support body is pivotally mounted between said pairs of connectors whereby to displace said beam of light to a desired location.

13. An LED lighting device as claimed in claim 1 wherein said LEDs are one of or a combination of coloured LEDs or white light LEDs.

14. An LED lighting device as claimed in claim 13 wherein said LEDs are coloured LEDs to enhance the appearance of foodstuff positioned in said display case.
